(19) United States
(12) Patent Application Publication
(10) Pub. No.: US 2018/0032717 A1
(43) Pub. Date: Feb. 1, 2018

(54) SECURITY SYSTEM FOR CASH HANDLING MACHINE

(71) Applicant: SEC ENG SYSTEMS PTY LTD, Caringbah, New South Wales 2229 (AU)

(72) Inventor: Shaun Cronin, Taren Point, New South Wales (AU)

(21) Appl. No.: 15/552,295

(22) PCT Filed: Feb. 24, 2016
(86) PCT No.: PCT/AU2016/050124

§ 371 Date: Aug. 20, 2017

(30) Foreign Application Priority Data
Feb. 27, 2015 (AU) 2015100234

(51) Int. Cl. G06F 21/44; G07D 11/00; G06F 21/88; G07F 19/00

(52) U.S. Cl. CPC G06F 21/44; G07F 19/203; G07D 11/0078; G06F 21/88

(57) ABSTRACT

The invention provides a security system for preventing unauthorised dispensing of cash from a cash dispenser (5), the cash dispenser (5) being located inside a physically protected area (10) of a cash handling machine (1), the cash handling machine having a host controller (2) outside the physically protected area (10) configured to issue dispensing instructions to the cash dispenser (5) over a dispensing instruction data link (3), the security system comprising: an access permission device (11) located inside the physically protected area (10) configured and connected to receive verification signals over a verification data link (2, 3, 22) and to block transmission of dispensing instructions over the dispensing instruction data link (3) to the cash dispenser if the verification signals are not received or are received but are incorrect; and access permission software operatively associated with the host controller (2) configured to send the verification signals to the access permission device (11).

### FIELD

The present invention relates to a system for securing cash handling machines against unauthorised operation of a cash dispenser. Cash handling machines include automated teller machines, but also any automatic machine which dispenses cash.

### BACKGROUND

Attacks on automatic teller machines and other cash handling machines have become a multi billion dollar organised crime industry and a new high technology level of intrusion attempts now exists in response to the tightening of conventional security methods.

A recent round of attacks involves the hijacking of control signals passing between a host controller and the cash dispensing device, to effectively cause the dispensing of cash by an intruder at will from a cash handling machine.

There is therefore a need to provide a system for securing cash handling machines against hijacking of the above-mentioned control signals.

### SUMMARY OF THE INVENTION

In accordance with a first broad aspect of the invention there is provided a security system for preventing unauthorised dispensing of cash from a cash dispenser, the cash dispenser being located inside a physically protected area of a cash handling machine, the cash handling machine having a host controller outside the physically protected area configured to issue dispensing instructions to the cash dispenser over a dispensing instruction data link, the security system comprising:

an access permission device located inside the physically protected area configured and connected to receive verification signals over a verification data link and to block transmission of dispensing instructions over the dispensing instruction data link to the cash dispenser if the verification signals are not received or are received but are incorrect; and

access permission software operatively associated with the host controller configured to send the verification signals to the access permission device.

In one embodiment, the security system is formed by installing the access permission device and the access permission software in a pre-existing cash handling machine, such that the access permission device is connected in line with the dispensing instruction data link between the host controller and the cash dispenser, and the access permission device performs the step of blocking instructions being transmitted over dispensing instruction data link by breaking the dispensing instruction data link.

In one embodiment, the verification data link and the dispensing instruction data link utilise a communications bus, and the access permission device is recognised by the host controller as a communications hub having at least two ports, with one port providing the verification data link and another port providing the dispensing instruction data link.

In one embodiment, the verification signals are derived using one or more encryption keys and the system is configured so that the one or more encryption keys can be remotely updated or replaced in the event of a security breach.

In one embodiment, the verification signals are sent periodically to the access permission device.

### BRIEF DESCRIPTION OF DRAWINGS

FIG. 1 is a block diagram of a conventional cash handling machine;

FIG. 2 is a block diagram of the cash handling machine of FIG. 1 modified by installation of an access permission device in accordance with an embodiment of the current invention; and

FIG. 3 is a block diagram of functional components of the access permission device of the embodiment of FIG. 2.

### DETAILED DESCRIPTION OF EMBODIMENTS

An embodiment of the current invention will now be described.

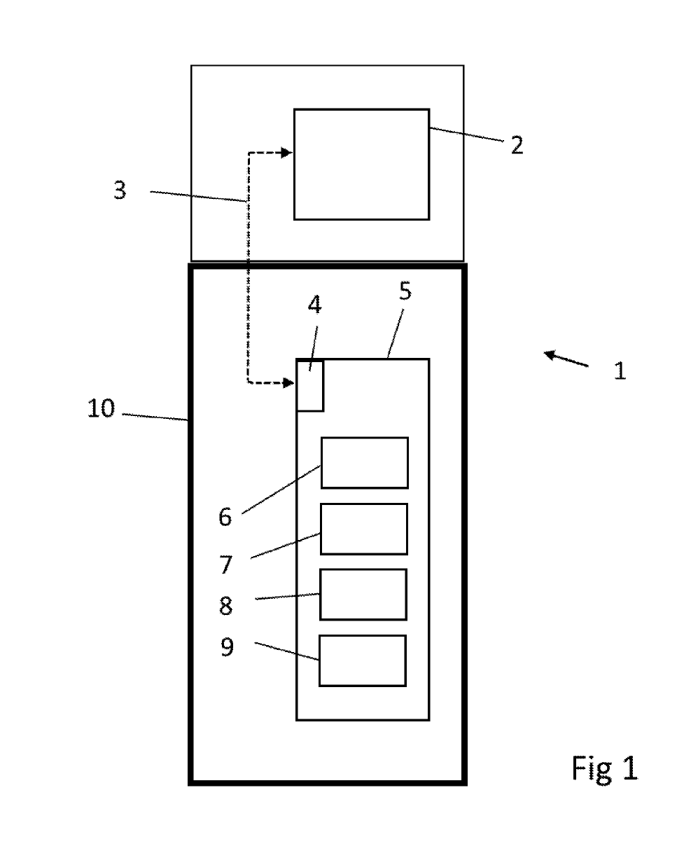

Referring first to FIG. 1, a block diagram of a conventional cash handling machine 1 shows a host controller 2 which may be based on a personal computer or other computer-based control system communicating over a cash dispensing instruction data link 3 in the form of a USB cable to a cash dispenser controller 4 of a cash dispenser 5 adapted to dispense cash from cash drawers 6, 7, 8, 9. Cash dispenser 5 is disposed within a physically protected area defined by an intrusion resistant container 10 so that the only way of accessing cash is via an appropriate instruction received by cash dispenser controller 4 through a cash dispensing slot (not shown). Typically, host controller 2 is a master computer which, in addition to cash dispenser controller 4, controls a user interface provided by a display, user input buttons including keypads, a printer, and a bank card reader.

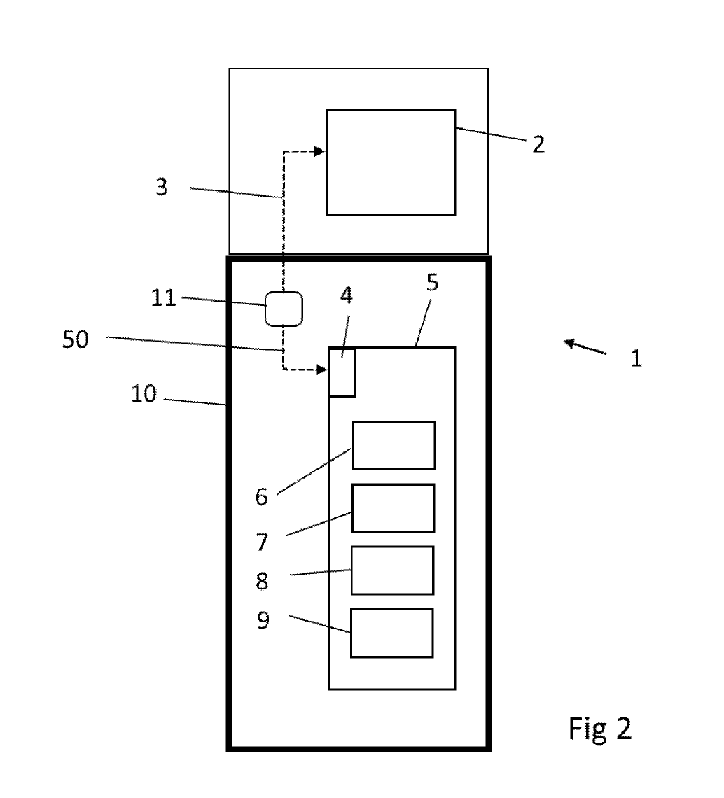

Now referring to FIG. 2, which is a block diagram of the cash handling machine of FIG. 1 modified by installation of an access permission device 11 in accordance with an embodiment of the current invention, it can be seen that access permission device 11 is connected in line with the dispensing instruction data link 3 and located inside the protected area defined by the intrusion resistant container 10

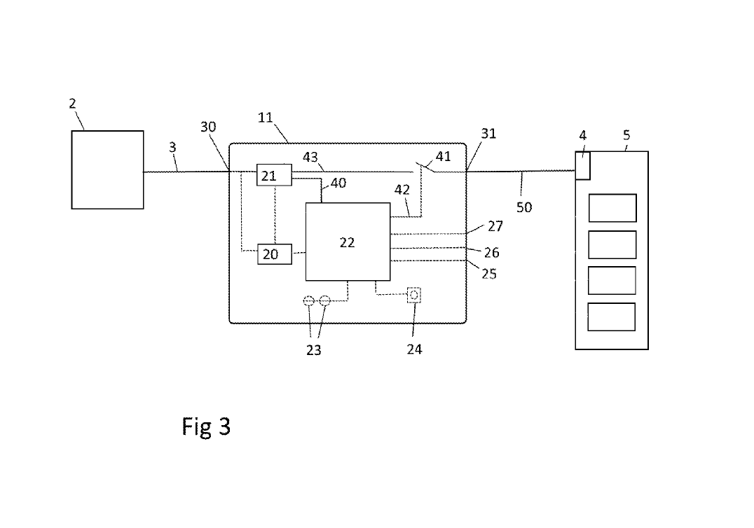

Now referring to FIG. 3, details of the access permission device 11 and its connections are shown. On installation in the pre-existing cash handling machine, a USB cable 3 which is originally connected as shown in FIG. 1 between host controller 2 and cash dispenser controller 4 is disconnected from cash dispenser controller 4 and reconnected to a first USB connector 30 of the access permission device 11. An additional USB cable 50 is then connected between a second USB connector 31 and cash dispenser controller 4. Dispensing instructions data link passes through connection 43 through connector 31 when switch 41 is closed, allowing dispensing instructions to proceed from host controller 2 to cash dispenser controller 4. When switch 41 is open, dispensing instructions are blocked. A microprocessor 22 and communications controller 21 are powered via power controller 20 from the USB power supply. Communications controller 21 is configured as a 2-port USB hub with one port connecting to the dispensing instruction data path via connection 43 and another port connecting to microprocessor via connection 40. Ancillary connections to microprocessor 22 include status LEDs 23, test switch 24, external communications bus 25, Digital output 26 and digital input 27 which together enable direct configuration and diagnosis if desired. Microprocessor 22 controls switch 41 through control line 42.

In addition to the installation of access permission device 11 in the dispensing instruction data link path, adaptation of the conventional cash handling machine also involves addition of software modules in host controller 2 enabling operation and establishment of the verification data link, and further involves a modification of peripheral initialisation procedures which ensure that the verification data link is established before at least the cash dispenser controller 4 is recognised and initialised, otherwise switch 41 will be open and communications with cash dispensing controller 4 over the USB interface will fail.

There are many approaches and protocols which can be used and are well known in the art to establish and maintain a verification data link between two connected devices. The method of this embodiment involves identical encryption keys stored in memory on both host controller 2 and microprocessor 22. The encryption key can be modified in the event of a security alert situation, such as may be presented by a detected intrusion attempt at one cash handling machine owned by the bank. This modification may be achieved by a central bank data processing centre loading down over a trusted secure communications link a new encryption key to host controller 2. Host controller 2 then sends the encryption key over the USB interface to microprocessor 22, ensuring that both devices share the same encryption key.

The verification data link operates by verification data signals between the host controller 2 and microprocessor 22 of access permission device 11 using the appropriate USB port number. In this embodiment, access permission device 11 periodically (typically once every 30 seconds or more frequently) initiates an authentication request by first producing a random number and sending the random number to host controller 2 over the verification data link. Host controller 2 transforms the random number using an encryption algorithm and the encryption key stored on host controller 2 and then sends the resulting transformed number back as a verification data signal to access permission device 11 over the verification data link. Microprocessor 22 then also transforms the random number previously generated using the same encryption algorithm and the encryption key stored on microprocessor 22, and checks that the transformed number so calculated is the same as the transformed number received from host controller 2. If the two numbers are not the same, or alternatively if no valid number is received from host controller 2 after a predefined interval, then the link is not verified and microprocessor 22 opens switch 41 to block communication over the dispensing instruction data link 3, 43, 50. Conversely, if the two numbers are the same then the link is verified and microprocessor 22 closes switch 41 to allow communication over the dispensing instruction data link 3, 43, 50.

As an alternative, in a variation of the above verification signal exchange the authorisation request could be initiated by the host controller 2 generating the random number and sending the random number and the transformed number as the verification data signal to the microprocessor 22, which can then perform the same calculation on the random number to check that the transformed number sent by host controller 2 is the same.

Because the added access permission device is contained within the physically protected area and will only allow dispensing instructions to pass if the verification signals are received indicating connection of the host computer, an intruder will be unable to operate the cash dispenser by severing the USB cable 3 and attempting to send cash dispensing instructions to the cash dispenser 5. Further in the embodiment shown above, a bank can retrofit an existing cash handling machine with the invention by the addition of the access permission device and software adjustments in the host controller.

Persons skilled in the art will also appreciate that many variations may be made to the invention without departing from the scope of the invention, which is determined from the broadest scope and claims.

For example, in its broadest aspect any method of providing a verification signal is contemplated, which may or may not include encryption keys, and the only fundamental requirement of the verification signal is that the signal effectively verifies connection of the host computer by sharing of a secret of some form between the access permission device and the host controller, which could be as simple as an unencrypted password. Many different such methods are known and a person skilled in the art will choose an appropriate method depending on the desired level of security.

Further, in other embodiments, the verification data link can be a separate physical data connection from the dispensing instruction data link, rather than passing over the same USB cable as in the embodiment above.

Further still, although in the embodiment described above the access permission software is contained within a software module in host controller 2, the access permission software needs only to be operatively associated with host controller 2 and could be operated from a separate unit in the unprotected area outside or inside host controller 2.

Also, the start-up and installations sequences and procedures described above are exemplary only.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. A security system comprising:
an access permission device; and
access permission software;
the security system configured to prevent unauthorized dispensing of cash from a cash dispenser, the cash dispenser being located inside a physically protected area of a cash handling machine, the cash handling machine having a host controller outside the physically protected area configured to issue dispensing instructions to the cash dispenser over a dispensing instruction data link;
the access permission device located inside the physically protected area configured and connected to receive verification signals over a verification data link and to block transmission of dispensing instructions over the dispensing instruction data link to the cash dispenser if the verification signals are not received or are received but are incorrect; and
the access permission software operatively associated with the host controller configured to send the verification signals to the access permission device.

2. The security system of claim 1, limited to an installation of the access permission device and the access permission software in a pre-existing cash handling machine, such that the access permission device is connected in line with the dispensing instruction data link between the host controller and the cash dispenser, and the access permission device performs the step of blocking instructions being transmitted over dispensing instruction data link by breaking the dispensing instruction data link.

3. The security system of claim 1, further comprising:
a communications bus configured for use by wherein the verification data link and the dispensing instruction data link; and
at least two ports in the access permission device, the host controller configured to recognize the access permission device as a communications hub configured so that one such port provides the verification data link and another such port provides the dispensing instruction data link.

4. The security system of claim 1 further comprising one or more encryption keys, each of the one or more encryption keys configured to derive the verification signals and to be remotely updated or replaced by the security system in the event of a security breach.

5. The security system of claim 1 configured to send the verification signals periodically to the access permission device.
